(19) United States
(12) Patent Application Publication
(10) Pub. No.: US 2025/0136478 A1
(43) Pub. Date: May 1, 2025

(54) Method for Operating a Reverse Osmosis Plant on a Body of Water; a Method for Operating a Reverse Osmosis Plant on a Body of Water; Reverse Osmosis Plant

(71) Applicant: Wilhelm Stirn, Heilbronn (DE)

(72) Inventor: Wilhelm Stirn, Heilbronn (DE)

(21) Appl. No.: 18/986,768

(22) Filed: Dec. 19, 2024

Related U.S. Application Data
(63) Continuation-in-part of application No. PCT/DE2023/100397, filed on May 26, 2023.

(30) Foreign Application Priority Data
Jun. 21, 2022 (DE) 102022115455.6
Jul. 13, 2022 (DE) 102022117540.5
Jul. 22, 2022 (DE) 102022118411.0
Nov. 11, 2022 (DE) 102022129877.9
Mar. 6, 2023 (DE) 102023105475.9
Mar. 6, 2023 (DE) 102023105477.5

(51) Int. Cl. C02F 1/44; B01D 61/02; B01D 61/10; C02F 103/08; C25B 9/65

(52) U.S. Cl. CPC C02F 1/441; B01D 61/025; B01D 61/10; C25B 9/65; C02F 2103/08; C02F 2201/001

(57) ABSTRACT

Methods for operating a reverse osmosis plant and a reverse osmosis plant are proposed, wherein a pressure difference is created at least at one reverse osmosis membrane of the reverse osmosis plant, wherein the pressure difference is created at least partially by taking advantage of natural geographical characteristics, whereby a smaller amount of direct pressure needs to be created for operating the plant, which makes the operation of the reverse osmosis plant less energy-intensive.

### CROSS REFERENCE TO RELATED APPLICATIONS

This application is a continuation-in-part of International Application No. PCT/DE2023/100397, filed on 2023 May 26. The international application claims the priority of DE 102022115455.6 filed on 2022 Jun. 21; the priority of DE 102022117540.5 filed on 2022 Jul. 13; the priority of DE 102022118411.0 filed on 2022 Jul. 22; the priority of DE 102022129877.9 filed on 2022 Nov. 11; the priority of DE102023105477.5 filed on 2023 Mar. 6; and the priority of DE 102023105475.9 filed on 2023 Mar. 6; all applications are incorporated by reference herein in their entirety.

### BACKGROUND

The invention is based on a method for operating a reverse osmosis plant on a body of water according to the preamble of claim 1, on a method for operating a reverse osmosis plant on a body of water according to the preamble of claim 11 and on a reverse osmosis plant according to the preamble of claim 14.

The transformation of salt water into purified (drinking) water, in particular by means of reverse osmosis, has long been the state of the art. Access to drinking water is a challenge particularly in arid regions and in countries with a population having low purchasing power, which is why there is a need for more affordable production methods.

Reverse osmosis combined with energy conversion processes has also been known for a long time. WO 2014/100674 A1, WO2012/131621 A1, and WO 2020/068775 A1, for example, describe wave power stations that drive a reverse osmosis plant. Combinations including energy conversion processes connected downstream are also known, such as the utilisation of purified water produced by reverse osmosis for electrolytic water splitting, as described, inter alia, in WO 2019/172775 A1, in which gas bubbles generated by electrolysis are used to carry the purified water up to the surface in a riser. Printed publication DE 10 2013 017 914 A1, for example, describes a method for connecting an off-shore wind park in which, subsequent to a prior desalination of sea water by way of reverse osmosis, hydrogen is obtained from water and, for ease of transportation, may then be converted into methane. These methods disadvantageously involve high energy costs for reverse osmosis, electrolysis, and transportation.

A comparable method essentially forms the basis of patent specification DE 197 14 512 C2, which discloses a maritime power plant. The maritime power plant, for example, has the advantage over DE 10 2013 017 914 A1 that it takes advantage of the pressure reigning in the depth of the sea, or depth pressure, for facilitating reverse osmosis. The disadvantage of this plant is that it still requires a great amount of energy expenditure for operating the plant. A submarine reverse osmosis plant for operation at a depth of over 550 meters is also described in DE 10 2015 2019 217 A1.

### SUMMARY

It is therefore an object of the invention to provide a method for operating a reverse osmosis plant on a body of water that overcomes the disadvantages of the state of the art, a method for operating a reverse osmosis plant on a body of water that overcomes the disadvantages of the state of the art and a reverse osmosis plant that overcomes the disadvantages of the state of the art.

### DETAILED DESCRIPTION

The inventive method for operating a reverse osmosis plant on a body of water having the characteristics of claim 1, the inventive method for operating a reverse osmosis plant on a body of water having the characteristics of claim 11, and the inventive reverse osmosis plant having the characteristics of claim 14 have, in contrast, the advantage that in the inventive method for operating a submarine reverse osmosis plant, a pressure difference is created at least at one reverse osmosis membrane of the reverse osmosis plant, wherein the reverse osmosis plant has a container and a reverse osmosis membrane is built into the container, wherein the container is sunk down to a depth of the sea that creates a depth pressure sufficient to urge water through a reverse osmosis membrane, and the container is subsequently sunk further down or the container is subsequently transported back again to the surface of the sea, whereby a smaller amount of direct pressure needs to be created for operating the plant, which makes the operation of the reverse osmosis plant less energy-intensive. It would also be envisageable to employ a combination consisting of classic pumps (such as flow pumps or positive displacement pumps) and natural pressure generation, for example through depth pressure. The high pressure in front of the reverse osmosis membrane and the low pressure behind the reverse osmosis membrane, the latter being preferably in the range of atmospheric pressure, will then represent a sufficiently high pressure difference for the operation of the reverse osmosis plant, or it might alternatively be conceivable that, in addition, one or more pumps are being used in order to increase the pressure level in front of the reverse osmosis membrane or to further lower it behind the reverse osmosis membrane, thus increasing the conveying speed and/or improving the amount of purified water per unit of time. It would be conceivable that additional pre-filters are connected in front of the reverse osmosis plant so that pre-purified water is introduced therein in order to not overuse the reverse osmosis membrane. In this context, it would also be conceivable that the flow direction within the reverse osmosis plant can be reversed so that the feed pipe of a reverse osmosis plant can be exchanged with the discharge pipe for the enriched brine, whereby, in particular, pre-filters and the like can be rinsed clear.

It would also be conceivable that the reverse osmosis membrane is installed in a sinker that is sunk from the surface of a body of water into the water, wherein said sinker is filled with air and wherein, as soon as a sufficient water depth has been reached, the prevailing depth pressure will cause water to flow through the reverse osmosis membrane and into the interior of the sinker and, in the course of this process, to be purified, and the sinker is then brought back up to the surface again. In this regard, it is conceivable that the depth pressure is at least as high as the working pressure required for the proper functioning of the reverse osmosis membrane. In this context, it would be conceivable that the reverse osmosis plant is sunk to a depth at which there reigns a depth pressure (e.g. almost 55 bar at a depth of 550 m) that is higher than the pressure (e.g. 50 bar) required for the operation of the reverse osmosis membrane. In this regard, it would be conceivable that the depth pressure and/or the selected membrane are adapted to each other, and therefore have a correspondingly ideal pressure difference, such that an optimal filtering speed of the reverse osmosis membrane is achieved. It would also be conceivable that by pumping or the like, the pressure reigning in front of the reverse osmosis membrane is further increased.

According to an additional advantageous configuration of the inventive method, filtered water is produced by the reverse osmosis plant and the filtered water is transported to an end user and/or to a distribution point, said filtered water being transported by means of at least one buoyancy body, for example a gas container. This has the advantage that the purified water can reach the consumer as a product of reverse osmosis. It would be conceivable that the pressure behind the reverse osmosis membrane is higher than the atmospheric pressure and can thus be used to distribute the purified water produced. It would be conceivable that in the case of a submarine reverse osmosis membrane, the purified water is passed on through a pipe system or is collected in containers that can rise and be carried to the surface by means of buoyancy bodies. It would also be conceivable that the buoyancy bodies realised in the form of gas containers are permanently connected to the container into which at least part of the purified water is introduced, and that these are then taken down together with the container when the latter is sunk again from the sea surface.

According to a pertinent advantageous configuration of the inventive method, at least one buoyancy body is filled with at least one gas, preferably at least partially with hydrogen or oxygen. This has the advantage that gases can expand as they rise and may thus speed up the ascent process. It would be conceivable that at least one buoyancy body is made either of an expandable material, which will expand together with the expanding gas in its interior due to the diminishing external pressure as the buoyancy body rises, or of a pressure-resistant material, by which the expansion of the gas, and thus the buoyancy, are kept within relative limits. It would also be conceivable that the buoyancy bodies could allow gas to flow out in order to slow down and/or limit the buoyancy, since the increasing buoyancy is counteracted by a steadily diminishing water column and thus weight force, and the gas containers rising from the depths will therefore continuously accelerate their ascent. In this regard, it would be conceivable that during the ascent, the depth in relation to time is determined via a depth gauge for the purpose of calculating the ascent speed and said ascent speed is regulated by releasing gas from at least one gas container, which causes the ascent to be slowed down. In this sense, it would preferably be conceivable to release oxygen.

According to a pertinent advantageous configuration of the inventive method, at least one gas, preferably hydrogen and/or oxygen, has been produced by electrolysis. Preferably, electrolysis is carried out at the site where reverse osmosis takes place, or relatively close thereto, which has the advantage that there is no need to transport the gases over a longer distance to the buoyancy bodies. However, it would also be conceivable that the electrolysis and reverse osmosis are carried out at different ocean depths and the buoyancy bodies are filled at the point of electrolysis and then, on their path of ascent, are conveyed, or move, to the reverse osmosis plant where they pick up a container with purified water and transport it further on. It would also be conceivable that the purified water obtained from reverse osmosis is used for electrolysis. In this regard, it would therefore be conceivable that part of the purified water is converted into hydrogen and oxygen and these gases would then be used to transport another part of the purified water to the sea surface. Depending on the efficiencies of the electrolysers and of the reverse osmosis plants used, the amounts that are converted and transported may be adjusted. It would also be conceivable that a container is used to transport the purified water from at least one reverse osmosis plant between this reverse osmosis plant and at least one electrolyser.

According to a pertinent advantageous configuration of the inventive method, electrolysis is at least partially operated by means of electrical energy that has been generated by at least one energy converter converting mechanical energy into electrical energy, such as a dynamo, a propeller or the like, which makes it possible for the electrolysis to be operated in an energy-efficient manner. It is obviously also conceivable that for electrolysis to take place, the electrolyser may be supplied with electric energy originating from a variety of energy sources, such as electrical energy produced by at least one energy converter and electrical energy coming from another source, such as an osmosis or wave power plant or from a regenerative source, such as sunlight or wind power. It would also be conceivable to reduce the ascent speed by connecting energy converters that convert mechanical energy into electrical energy (such as dynamos or water propellers). It would further be conceivable to have at least one guide along which at least one container that has been filled with pre-purified water and/or air at the sea surface is transported to at least one submarine reverse osmosis plant and/or along which at least one container that has been filled with purified water is transported to at least one electrolyser for the purpose of undergoing electrolysis. It would also be conceivable that the container will at least partially sink down to the submarine reverse osmosis plant due to its own weight. It would also be conceivable that the guide is in the form of a rope, a pipe, a hose, a cable or the like. It would further be conceivable that at least one guide is attached to a sea shore, a to platform floating in the sea or to at least one ship. In this regard, it would be conceivable that the guide leads from the electrolyser back to the sea surface, where it is attached either to a sea shore, to a platform floating in the sea or to at least one ship, or that it leads from a sea shore, from a platform floating in the sea or from at least one ship to the reverse osmosis plant. Furthermore, it would be conceivable that at least one container has at least one energy converter attached thereon, which, in a relative movement, can slide along the at least one guide and by which the mechanical energy generated by sliding along the at least one guide is converted the into electrical energy. In this sense, it would be conceivable that the energy converter is a dynamo or other electrical generator that exploits induction effects. In this sense, it would further be conceivable that at least one guide includes a current-conducting component that transmits electrical energy generated by at least one energy converter to at least one electrolyser. It would be conceivable that said electrical energy originates from a source such as an osmosis or wave power plant or from a regenerative source, such as sunlight or wind power.

According to a pertinent advantageous configuration of the inventive method, the energy converter is moved from an elevated position with high potential energy to a position with lower potential energy, preferably so by a weight force, thus simultaneously generating electrical energy, whereby the naturally given weight force can be used to generate energy. In this context, it would be conceivable that, for example, a means of locomotion placed on top of a mountain, slope or the like, is moved down the slope while energy converters will convert the kinetic energy into electricity. These could be, for example, dynamos that are moved along a surface, as well as propellers that convert the draught into electrical energy or the like. It would also be conceivable to lay tracks leading down from a mountain, slope or the like. In this sense, it would further be conceivable that the tracks would be laid in a reversible manner, while it would be conceivable, in particular, that the tracks or track elements are designed to be rollable and may thus be rolled out and rolled up again in a simple manner. It would also be conceivable that the means of locomotion can be used for downhill transport of boulders, sediment, snow, ice, water and/or other transportable goods from a position with high potential energy, such as a mountain peak. In this sense, a change in temperature, for example from a mountain peak down to the valley, could in particular cause a change in aggregate state, i.e. preferably a melting of snow and/or ice, which can then, once turned into water, be used in a reverse osmosis plant as water to be purified, or be used for water splitting carried out in an electrolyser.

According to a pertinent advantageous configuration of the inventive method, the weight force is increased by an additional weight body and thus the energy converter moves down more quickly to a position with lower potential energy. It would be conceivable that the movement of at least one container towards the (sea) bottom is accelerated by additional weights and/or by a drive mechanism, and/or that the movement of at least one container towards the (sea) surface is accelerated by a drive mechanism. In this sense, it would be conceivable that the drive mechanism is driven by a motor, in particular an electric motor and/or an internal combustion engine. It would also be conceivable that additional weights, such as sandbags, are used when moving towards the (sea) bottom in order to achieve a faster descent. In addition, it would also be conceivable that compressed air bottles are carried downwards, which may then be introduced into a separate gas container for generating additional buoyancy.

The inventive method for operating a reverse osmosis plant on a body of water, wherein said body of water has a water bottom and a water surface, has the advantage over the prior art, that the reverse osmosis plant is positioned at a height a between the water surface and the water bottom and at least one electrolyser is positioned at the height a or at the height b between the reverse osmosis plant and the water bottom, and that water is split into hydrogen and oxygen at the electrolyser, that the resulting oxygen and/or hydrogen is introduced into at least one gas container, that purified water is produced at the reverse osmosis plant, that the purified water is introduced into at least one container, that at least one gas container is attached or is being attached to said at least one container, and that the at least one container is pulled up to the water surface by means of at least one gas container, thereby enabling a low-energy transport of the purified water to the sea surface.

According to an additional advantageous configuration of the inventive method, electrolysis is at least partially operated by means of electrical energy that has been generated by at least one energy converter converting mechanical energy into electrical energy, such as a dynamo, a propeller or the like, wherein the energy converter is moved, preferably by a weight force, from an elevated position with high potential energy to a position with lower potential energy and generates electrical energy in the course of this movement.

According to an additional advantageous configuration of the inventive method, the weight force is increased by an additional weight body and thus the energy converter moves down more quickly to a position with lower potential energy.

According to an additional advantageous configuration of the inventive method, a pressure difference on at least one reverse osmosis membrane of the reverse osmosis plant is created as claimed in any one of claims 1 to 9.

The inventive reverse osmosis plant, which is configured for carrying out a method as claimed in any one of claims 1 to 14, has the advantage over the prior art that it works efficiently and with reduced energy requirement.

It would further be conceivable that a pressure-stable hose and/or piping system is used to transport pre-purified water from the sea surface to at least one reverse osmosis plant and/or to transport purified water from at least one reverse osmosis plant to at least one electrolyser. It would also be conceivable for hydrogen and/or oxygen to be transported towards the sea surface via a hose and/or piping system. An exemplary device could consist of at least one reverse osmosis plant and at least one electrolyser, and at least one reverse osmosis plant and at least one electrolyser would be directly or indirectly connected to each other in such a manner that part of the purified water produced by at least one reverse osmosis plant from salt water and/or pre-purified water can be transported to at least one electrolyser which produces hydrogen and oxygen therefrom, and that gas containers are reversibly connected to at least one electrolyser and are connected therewith in such a manner that the hydrogen and the oxygen produced can be passed separately into the gas containers or that the hydrogen or oxygen produced can jointly be passed into one gas container, such that the gases can be collected and may subsequently be used for transporting the container. It would be conceivable that the gas containers are firmly connected to the container that can be filled with pre-purified water or salt water. It would further be conceivable that at least one reverse osmosis plant and at least one electrolyser are connected to each other by means of a guide and/or a pressure-resistant hose and/or piping system.

It would be conceivable that the products obtained, in particular hydrogen and oxygen, are used for land-based energy production. It would also be conceivable that the purified water is used as drinking water.

Further advantages and advantageous configurations of the invention may be found in the following description, in the claims and in the drawings.

### BRIEF DESCRIPTION OF THE DRAWINGS

Preferred embodiment examples of the object of the invention are represented in the drawings and will be described hereunder in greater detail. In the drawings:

FIG. 1 is a schematic representation of the inventive method or operating a reverse osmosis plant at two ocean depths,

FIG. 2 is a schematic representation of the inventive method at one ocean depth,

FIG. 3 is a schematic representation of the inventive method at two ocean depths, including a hose and/or piping system.

### DETAILED DESCRIPTION OF THE PREFERRED EMBODIMENTS

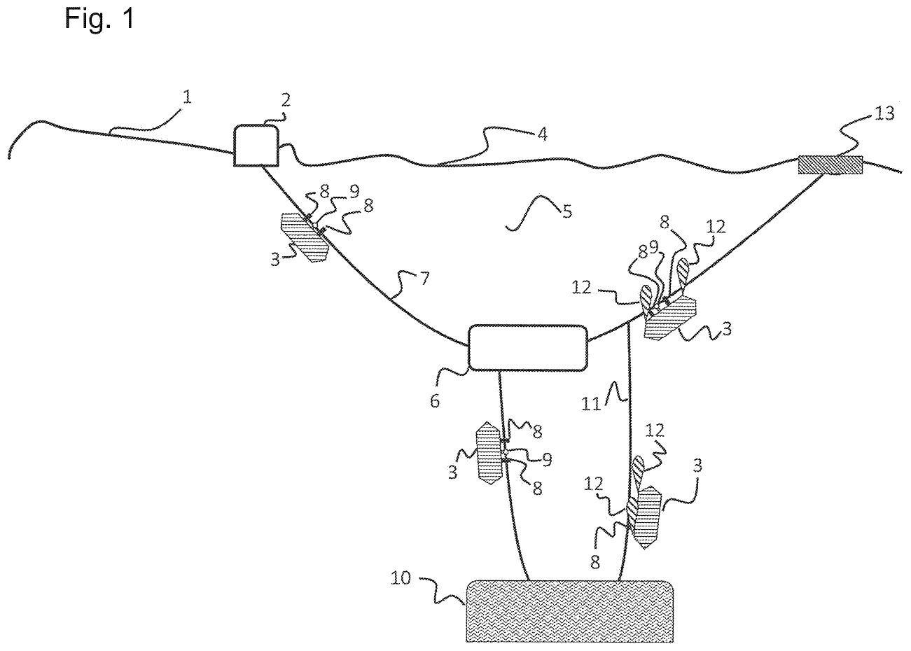

FIG. 1 shows a schematic representation of the inventive method for operating a reverse osmosis plant at two ocean depths. On the sea shore 1, sea water and/or salt water is first pre-purified in a pre-purifying station 2 such that pre-purified water is obtained, which has been cleared from suspended matter and already has a lower salinity than the original salt water. This pre-purified water is charged into a pressure-resistant container 3. Subsequently, the container 3 sinks down from the sea surface 4 into the sea 5 and to a reverse osmosis plant 6, to which it is coupled. Upon sliding down, the container 3 is guided along a guide 7 to which it is attached by means of fastening means 8. The fastening means 8 allow the container 3 to slide along the guide 7. During this process, energy converters 9, in this case dynamos, come into contact with the guide 7 and convert the kinetic motion energy into electrical energy, which is passed to the reverse osmosis plant 6 and on to an electrolyser 10 via the guide 7, which has a current-conducting component in the form of a built-in cable. The pre-purified water can be forced out of the container and into the reverse osmosis plant by the depth pressure reigning in the container 3, which has, for example, a lockable pressure plate that can be returned once the pre-cleaned water has been pressed out, while it is simultaneously compressed, for example, to almost 50 bar at an ocean depth of −500 m. It would also be conceivable that the water to be purified is pressed out by pumping or mechanically. In the reverse osmosis plant 6, the pre-purified water is subsequently pressed through the filter membrane, behind which a pressure of approximately 1 bar is applied. The concentrated brine is flushed out into the sea 5 and the purified water is filled back into the container 3 and/or into another comparable container. A check valve at the exit for the concentrated brine can prevent the incoming water to be purified from having to work against the depth pressure. During the filtering process, the concentrated brine and the purified water flow out of the reverse osmosis plant 6, so that the pressure therein decreases and is rebuilt by the subsequent, new inflow of water to be purified. The container 3, now filled with purified water, sinks down, again along a guide 11, to the electrolyser 10. The container 3 is coupled thereto and directs part of the purified water into the electrolyser 10, in which the gases oxygen and hydrogen are obtained from the purified water. In principle, it would also be conceivable for the electrolyser 10 to work with salt water. The gases oxygen and hydrogen are collected in separate gas containers 12. These expand and generate additional buoyancy, which allows the container 3 to be moved back up to the sea surface 4. At an extraction point 13, both the purified water and the gases hydrogen and oxygen are respectively withdrawn from the container 3 and from the gas containers 12. Basically, it would of course also be conceivable to skip the pre-purifying step and to have the container 3 sink down to the reverse osmosis plant 6 filled with air, in which case seawater would be used for reverse osmosis. It would also be conceivable that different containers 3 are used for the various different transport steps.

It would be conceivable that the container 3 has a second container attached thereto, which serves for receiving the air present in the container 3 which is pushed out as the latter is being filled with purified water. In this regard, it would be conceivable that the container is an expandable gas container that equally generates buoyancy during ascent.

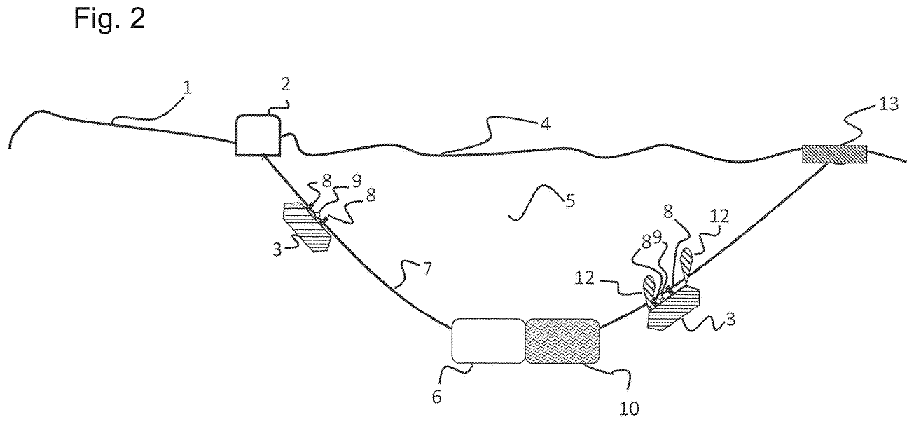

FIG. 2 shows a schematic representation of the inventive method at one ocean depth in which the electrolyser 10 is directly connected to the reverse osmosis plant 6.

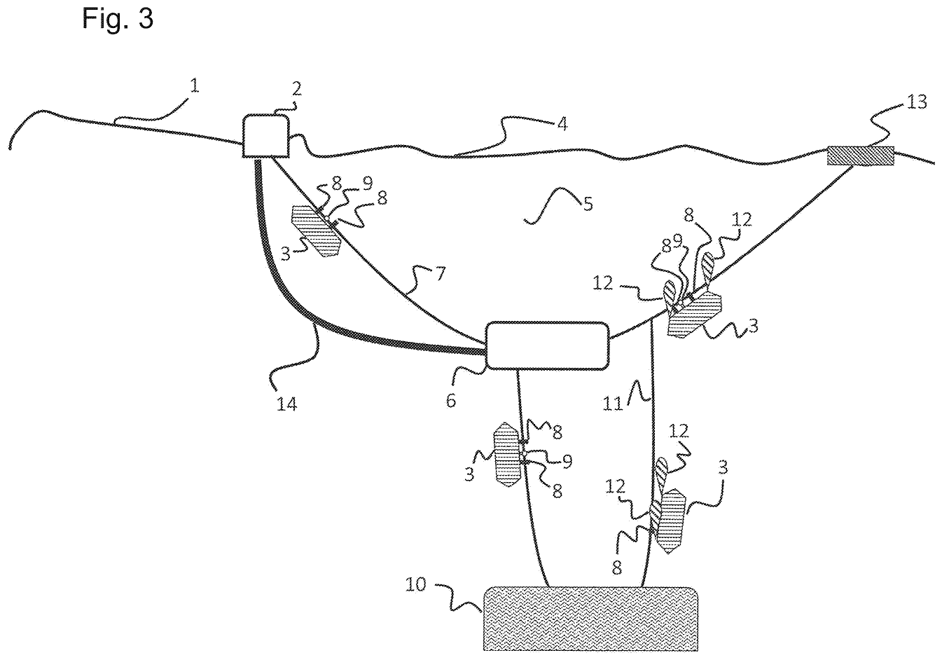

FIG. 3 shows a schematic representation of the inventive method at two ocean depths, including a hose and/or piping system as an alternative embodiment. Accordingly, it would be conceivable that pre-purified water from the sea shore 1 is transported to the reverse osmosis plant 6 via a hose and/or piping system 14, the pre-purified water being apt to be compressed by the depth pressure so that it arrives at the reverse osmosis plant 6 at the required working pressure of, for example, 50 bar. In this case, the container 3, filled with air, would sink down to the reverse osmosis plant 6 and be filled there with purified water.

In this regard, it would be conceivable that part of the purified water would be transported back to the sea surface 4 via a hose and/or piping system 14.

In a further embodiment example, a heavy container 3, which is pressure-deformation resistant up to approx. 55 bar, (shaped in a cost-effective manner in the form of a ball), e.g. a steel barrel body, —filled with surface air—is sunk down to a working depth of an osmosis membrane of over −550 m (the pressure of the purified seawater there is approx. 55 bar) or sinks to this depth and is coupled to the reverse osmosis plant 6. Here its internal air volume fills with water purified by the osmosis membrane. This container 3 then continues to sink along the guide 11, which continues almost vertically downwards, to the lowest possible bottom (suitable choice of location). In this process, gravity is used by energy converters 9 to produce as much electrical current as possible. The electrical current is used to produce hydrogen and oxygen, each of which is introduced in separate gas containers 12 (elastic, up to pre-built maximum size).

The energy converters 9, here in the form of dynamos, thus use gravity or buoyancy for motion-related electrical power production when descending and ascending. Subsequently, electrolysis is carried out in order to further meet the reason of power generation which is part of the plant design.

The two gases, hydrogen and oxygen, which have been produced at the sea bottom by means of electrolysis, are then filled into separate gas containers 12 and pull the container 3, which is filled with purified water, up to the sea shore or to a ship or to a platform for emptying.

For concentricity production, a guide 3 consisting of two curvable inner tubes may be hung out, for the purpose of gas and/or water transformation on the sea shore 1, from there and a boat or between boats, in a U-shape with a given depth (depending on the module specification) with its tip at e.g. −550 m.

On the sea shore 1 and/or on a ship and/or on a platform, depending on accessibility, the salt water to be desalinated is first pre-purified. Once the pre-purification step has been accomplished, the pre-purified water is passed on to the reverse osmosis plant 6 via at least one conduit.

The gas containers 12 may consist, for example, of a flexible (overpressure-storing, “water-expelling”) volume that can be limited by a metal (film) form. When filled with gas, this volume will increase during its ascent, in accordance with the varying relationship between external pressure and internal pressure.

The container 3, which is already denser, i.e. heavier than the surrounding seawater, when filled with air, will become further compacted as it is filled with purified water and thus will sink further down, charged with additional weight. During this step, dynamos or energy converters 9 may be electrically connected and will use the sinking force/movement of the body to produce electrical current therefrom.

It would also be conceivable that the reverse osmosis plant is configured in such a way that the inlet for water to be purified and the outlet for the concentrated brine may be inverted, which makes it possible for the reverse osmosis membrane and for any pre-filters that may be present to be flushed free by changing the flow direction.

In a further embodiment example, a container is sunk down to a sea depth that generates sufficient depth pressure to force water, in particular pre-purified water, through a reverse osmosis membrane behind which there is preferably a normal pressure of approximately 1 bar. The reverse osmosis membrane is built into the container and automatically begins filtering the water when the appropriate depth has been reached, thereby gradually filling the space behind the membrane with purified water, which causes the pressure behind the membrane to gradually increase and, consequently, the production of purified water will by and by come to a standstill. The container can subsequently be transported back to the sea surface, using, for example, gas containers whose buoyancy will bring the container up to the surface. The gases used to fill the gas containers may, for example, be produced at the ocean depths or on land and may, for example, include hydrogen and oxygen, which are produced in particular from part of the generated purified water via a water splitting reaction taking place in an electrolyser.

In a further embodiment, a means of locomotion placed in a position with high potential energy, such as a mountain, is first filled with, for example, boulders, snow and/or ice. The means of locomotion is preferably made of a lightweight construction, for example of plastic, aluminium or the like, and preferably runs on rails. These are laid in a downward direction and are rails apt to be laid, in particular, in a reversible way so that they can, for example, be rolled out and rolled up again at a later stage. The means of locomotion can then roll down the slope and transport its cargo into the valley, with the transported cargo of ice and snow melting during transport. During this transport movement, energy converters attached to the means of locomotion produce electricity, which can be stored or can be used for electrolysis of the water formed from the molten cargo. The gases resulting from electrolysis, preferably oxygen and hydrogen, can be collected in gas containers and could be used to slow down the means of locomotion and, if necessary, to transport it back to its starting point more easily. The means of locomotion can further be moved into a body of water and can sink down therein, provided said container is apt to be used and coupled according to the methods for operating a reverse osmosis plant as described in the above-mentioned embodiment examples. Obviously, each separate process step can be freely combined with any of the other steps.

All of the characteristics represented herein, as considered either in themselves or in any combination with each other, may be deemed essential to the invention.

### LIST OF REFERENCE NUMERALS

1 sea shore
2 pre-purifying station
3 container
4 sea surface
5 sea
6 reverse osmosis plant
7 guide
8 fastening means
9 energy converter
10 electrolyser
11 guide
12 gas container
13 extraction point
14 hose and/or piping system

1. A method for operating a submarine reverse osmosis plant,
wherein said reverse osmosis plant has a container,
characterised in that
said container has a built-in reverse osmosis membrane,
the container is sunk down to a sea depth that generates sufficient depth pressure to force water through a reverse osmosis membrane, and
the container is subsequently sunk further down or the container is subsequently transported back to the sea surface again.

2. The method as claimed in claim 1,
characterised in that
the container filled with filtered water is transported back to the sea surface,
wherein said container is transported by at least one buoyancy body, such as a gas container.

3. The method as claimed in claim 1,
characterised in that
at least one buoyancy body is filled with at least one gas, preferably at least partially with hydrogen or oxygen, wherein said at least one gas has been produced on land or in the submarine depths.

4. The method as claimed in claim 3,
characterised in that
at least one gas, preferably hydrogen and/or oxygen, has been produced by electrolysis.

5. The method as claimed in claim 4,
characterised in that
electrolysis is at least partially operated by means of electrical energy that has been generated by at least one energy converter converting mechanical energy into electrical energy, such as a dynamo, a propeller or the like.

6. The method for operating a reverse osmosis plant as claimed in claim 5,
characterised in that
the energy converter is moved from an elevated position, preferably the sea surface 4, with high potential energy to a position with lower potential energy,
preferably so by a weight force, thus simultaneously generating electrical energy.

7. The method for operating a reverse osmosis plant as claimed in claim 6,
characterised in that
the weight force is increased by an additional weight body and thus the energy converter moves down more quickly to a position with lower potential energy.

8. The method for operating a reverse osmosis plant as claimed in claim 1,
characterised in that
the container is fastened to a guide (7) by fastening means (8) and slides along that guide.

9. The method for operating a reverse osmosis plant as claimed in claim 8,
characterised in that
the guide comprises a current-conducting component, preferably a built-in cable.

10. The method for operating a reverse osmosis plant as claimed in claim 9,
characterised in that
the guide is connected to an electrolyser and current is transmitted to an electrolyser via the current-conducting component and is used there for electrolysis.

11. A method for operating a reverse osmosis plant on a body of water
wherein the body of water has a water bottom and a water surface (4),
characterised in that
the reverse osmosis plant (6) is positioned at a height a between the water surface (4) and the water bottom and at least one electrolyser (10) is positioned at a height a or at a height b between the reverse osmosis plant (6) and the water body, and
at the electrolyser (10) water is split into hydrogen and oxygen,
the generated oxygen and/or hydrogen is introduced into at least one buoyancy body (12),
at the reverse osmosis plant purified water is produced,
at least one container (3), wherein the container (3) is a pressure-resistant container, sinks down along a guide (7) from the water surface (4) to the reverse osmosis plant (6) and is coupled thereto,
the purified water is introduced into the at least one container (3),
at least one buoyancy body (12) is attached or is being attached to said at least one container (3), and
the at least one container (3) is pulled up to the water surface (4) by means of at least one buoyancy body (12).

12. The method as claimed in claim 11,
characterised in that
electrolysis is at least partially operated by means of electrical energy that has been generated by at least one energy converter (9) converting mechanical energy into electrical energy, such as a dynamo, a propeller or the like, and the energy converter sinks down, preferably by a weight force, from the water surface (4) and generates electrical energy in the course of this movement.

13. The method as claimed in claim 11,
characterised in that
the weight force is increased by an additional weight body and thus the energy converter sinks down more quickly.

14. A reverse osmosis plant configured to carry out a method as claimed in claim 11.
